(19) United States
(12) Patent Application Publication
(10) Pub. No.: US 2005/0050368 A1
(43) Pub. Date: Mar. 3, 2005

(54) Multiple-purpose power supply after computer is switched off

(75) Inventor: Steven Su, Taoyuan (TW)

Correspondence Address: TROXELL LAW OFFICE PLLC;SUITE 1404, 5205 LEESBURG PIKE, FALLS CHURCH, VA, 22041, US

(73) Assignee: Enermax Technology Corporation

(21) Appl. No.: 10/648,259

(22) Filed: Aug. 27, 2003

(51) Int. Cl. G06F 1/26

(52) U.S. Cl. 713/300

(57) ABSTRACT

A power supply provides direct current power supply to peripheral devices inside or outside of a computer main unit after the computer system is switched off, to solve the problem of the prior art wherein power is no longer supplied to the components in the computer or peripheral devices after the computer main unit is switched off.

### BACKGROUND OF THE INVENTION

(a) Field of the Invention

The present invention relates to a multiple-purpose power supply that continues to supply power to CD-ROM, lamp tubes, small LED displays, or other peripheral devices that operate on direct current, after the computer main unit is switched off, so that the peripheral appliances are in operation at all times, without being interfered with by switching off the computer system.

(b) Description of the Prior Art

A regular computer main unit is equipped with a power supply, for converting an alternating current to a stable direct current of different voltages, to suit the requirements of different components installed inside the computer main unit.

In addition to the foregoing power supply, there is another design that includes a set of stand-by power output devices, providing minute current required to wake up the computer system when the motherboard is switched off, but the current output and the number of sets provided are not sufficient to meet the requirements of computer peripheral devices.

In addition to operating systems and other application software programs, applications of personal computer nowadays also include many independent operations, such as: playing music CDs directly from CD-ROMs, recharging of PDA, cell phones, etc. using USB interfaces, or viewing of temperature, humidity or time displayed on small LED monitors installed on casings, or viewing of light-emitting shining casings, etc. Such applications have to operate independently without the computer operating system being switched on. But the current design of the power supply is restricted to the above function only when the computer main unit is switched on.

### SUMMARY OF THE INVENTION

Summing up, the present invention of the power supply is a power device that supplies power at all times to CD-ROMs, lamp tubes, small LED displays, as well as other peripheral devices that require direct current powers, whether the main computer system is switched on or off.

### BRIEF DESCRIPTION OF DRAWINGS

FIG. 1 is a block diagram of the present invention of the computer power supply.

FIG. 2 is a simplified wiring diagram of XV auxiliary supply of power in the present invention of the computer power supply.

### DETAILED DESCRIPTION OF THE INVENTION

The present invention relates to a multiple-purpose power supply, operating by installing another auxiliary power supply device inside the power supply, providing two or more sets of output voltage to various peripheral devices inside or outside the computer main unit, thereby, even when the computer unit is switched off, the power supply is still capable of supplying direct current power to peripheral appliances. This independent auxiliary power works in a similar way as the main power supply, but supplies power to the peripherals or devices that are capable of independent operation without the computer's operating system; therefore, it delivers a power source with a lower wattage and fewer sets of voltage outputs. However, the auxiliary power supply is not a suitable source of power for peripheral devices or system components that have to operate along with the operating system, such as the central processor, chipset, hard disc driver, soft disc driver, graphic card, and related components.

Features that can be achieved by such division of power supply into two power outputs, a main power and an auxiliary power, include the following:
1. When the system is in operation, the main power and auxiliary power supply power simultaneously in the same way as the regular power supply.
2. When the system is switched off, the main power is also switched off, but the auxiliary power continues to supply power, permitting normal operation of peripheral appliances that do not have to work along with the operating system, and the following features:
   Better flexibility to multi-media functions: Light-emitting and music playing effects are provided even when the computer main unit is switched off, keeping in line with the trend of using computer products like other electrical household appliances.
   Excellent noise-free effect: When the CD-ROM is operated to play music after the computer main unit is switched off, there is no noise produced by other devices. So there can be better listening quality.
   Uninterrupted display of environment information: Small LED monitor installed on the computer casing is capable of displaying the ambient temperature, humidity, time, and other useful information detected from the ambient environment, even when the computer is switched off.
   Saving of power consumption: Since the foregoing peripheral devices consume less power than the entire operating system, and the auxiliary power supply has a lower output than the main power, power consumption shall be much less when the operating system is switched off, than when it is switched on.
   Simplified switching off procedure: The user can directly use the above function without waiting.
3. The voltage output of the auxiliary power supply can be installed on a push button or a knob control on the power supply, to have more flexibility of power utilization.

### DETAILED DESCRIPTION OF PREFERRED EMBODIMENTS

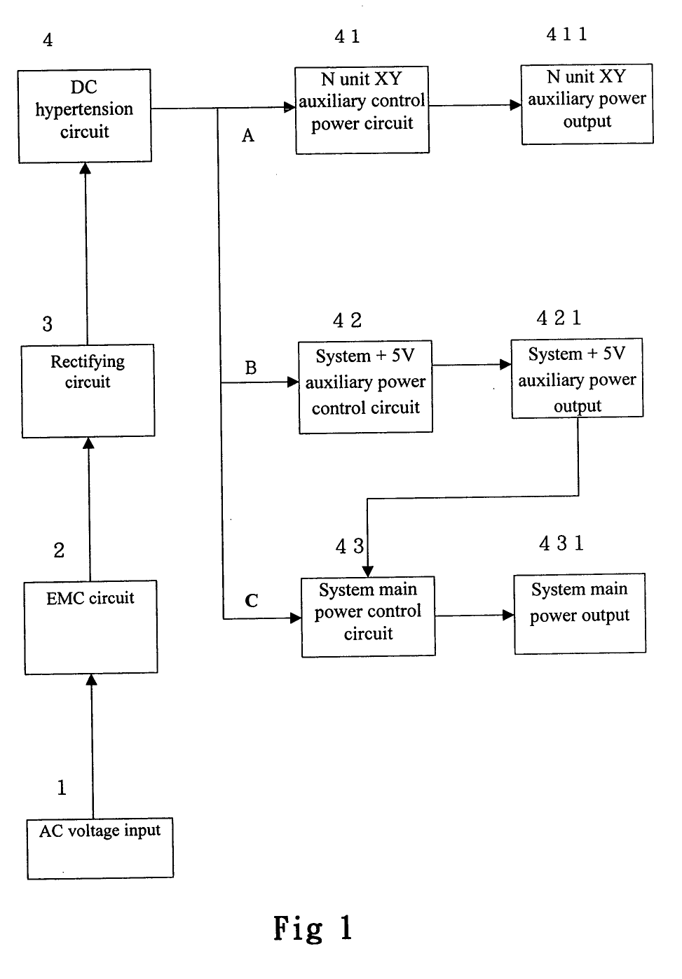

Please refer to FIG. 1 that illustrates a block diagram of the present invention of the computer power supply, wherein alternating current is delivered to an AC voltage input (1). After regulating and rectifying processes by a regular EMC circuit (2) and rectifying circuit (3), the alternating current is converted to direct current by a DC hypertension circuit (4).

After converting the power source, the direct current is divided by the DC hypertension circuit (4) into an XV auxiliary power supply (A), a system auxiliary power supply (B) and the system's main power (C).

In the XV auxiliary power supply (A), there is an N unit XY auxiliary control power circuit (41) for further regulation of the voltage and current, which are then provided by an N unit XY auxiliary power output (411) to other power outlets for independent use outside of the computer system (the voltage provided is generally 12V, or other voltages to be designed if so required). Thereby, the present invention of computer power supply is capable of supplying power to related peripheral devices, including CD-ROM, CD music player, or PDA or cell phones that need to be recharged by use of USB interface, or to a small LED display installed on a computer casing to indicate temperature, humidity, time, and other useful information, or to the computer casing provided with light-emitting effects.

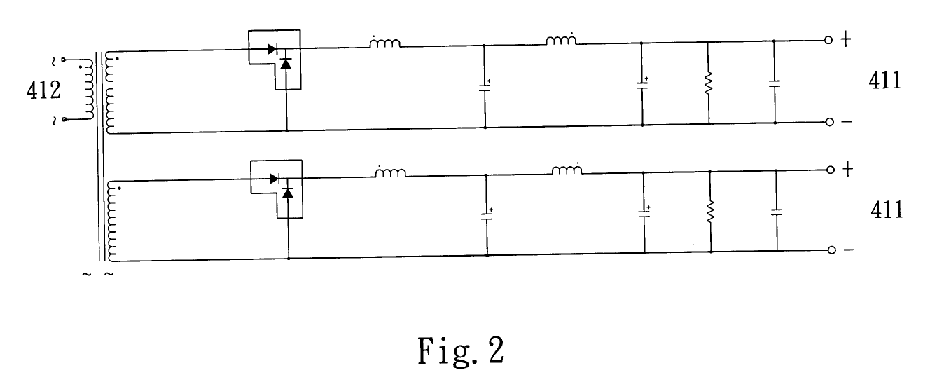

Please refer to FIG. 2 that illustrates a simplified wiring diagram of an XV auxiliary power supply (A) in the present invention of computer power supply, the wiring diagram including an independent coil (412) in the power supply, so it keeps on operating, whether the computer main unit is switched on or off, to provide power supply through the XY auxiliary power output (411). The output (411) is selectively divided into two or more units to supply power simultaneously to a variety of peripheral products.

The system auxiliary power supply (B) diverted from the DC hypertension circuit (4) has a system +5V auxiliary power control circuit (42), and a system +5V auxiliary power output (421) to deliver power into the system's main power control circuit (43) serving to activate the computer main unit when the main unit is switched on.

Likewise, in the system's main power (C) diverted from the DC hypertension circuit (4), there is a system main power control circuit (43). After regulation of the voltage and current, the system's main power output (431) provides power, with a variety of voltages including +5V, −12V and +12V, to the main system of the computer main unit, the disc driver and radiating fan.

Summing up, the present invention of the power supply is a power device that supplies power at all times to CD-ROMs, lamp tubes, small LED displays, as well as other peripheral devices that require direct current powers, whether the main computer system is switched on or off.

1. A multiple-purpose power supply that supplies power even after the computer's main unit is switched off, having a circuit framework comprising AC voltage input, an EMC circuit, a rectifying circuit and a DC hypertension circuit, for converting an alternating current to a direct current, characterized in that:
After the alternating current is converted to the direct current, the DC hypertension circuit is diverted into an XV auxiliary power supply, a system auxiliary power supply and a system main power, wherein the XV auxiliary power supply provides power to the main unit, permitting operation of all computer peripheral appliances, whether the computer main system is switched on or off.

2. The multiple-purpose power supply of claim 1, wherein, the XV auxiliary power supply has an N unit XY auxiliary control power circuit for regulation of voltage and current, and two or more sets of N unit XY auxiliary power output terminals for supply of power to a variety of peripheral appliances.

3. The multiple-purpose power supply of claim 1, wherein, the XV auxiliary power supply has an independent coil.
